(19) United States
(12) Patent Application Publication
(10) Pub. No.: US 2016/0112278 A1
(43) Pub. Date: Apr. 21, 2016

(54) DASHBOARD SUMMARY INDICATORS

(71) Applicant: Brocade Communications Systems, Inc., San Jose, CA (US)

(72) Inventors: Aruna Sangli, San Jose, CA (US); Arunmani Annamalai, San Jose, CA (US); Sathiapriya Sathiyagiri, Sunnyvale, CA (US); Murthy Bhetanabhotla, Sunnyvale, CA (US)

(21) Appl. No.: 14/517,814

(22) Filed: Oct. 18, 2014

(51) Int. Cl. H04L 12/24; G06T 11/20; G06T 11/00; G06F 3/0484

(52) U.S. Cl. CPC H04L 41/22; G06F 3/0484; G06T 11/206; G06T 11/001; G06T 2200/24

(57) ABSTRACT

Network elements in a network are displayed along with their corresponding measured network parameters, wherein the display of the parameters comprises a color coded bar or other visual indicator. Each color corresponds to a particular range of values of parameters (e.g., 25% to 50% range). A symbol is displayed for each range of values, where the symbol color matches the color for each particular range and the symbol includes a number representing the number of network elements falling within the range.

### BACKGROUND OF THE INVENTION

1. Field of the Invention

The invention relates to network device management and more particularly to displaying dashboard parameters relating to the performance of networking devices.

2. Description of the Related Art

Network management software provides network administrators a way of tracking the parameters of ports or switches in a network. As an example, for smaller networks with a fewer number of ports, closely monitoring port utilization in a graphical user interface (GUI) is a less arduous task. However, for large networks, there are often so many ports that the arrangement, organization and display of data values for each port based on predetermined parameters are necessitated. Current solutions to this problem offer organizing and arranging the ports or devices in several ways. Switch or device level parameter monitoring has some problems in many instances. As an example, one current solution, which is widely used, includes simply listing all of the ports and their corresponding parameters based on either the highest or lowest parameter of the ports. While this solution aids administrators in tracking port traffic, listing all of the ports is space consuming and not always necessary. Moreover, even when all of the ports are listed, it is not always clear, based on a simple glance by an administrator, how many ports are operating at a certain critical predetermined threshold for a particular parameter (e.g., bandwidth, dropped packets). Consequently, this solution does not always allow for quick viewing of ports to determine their overall performance so that the administrator can take action to reroute traffic before congestion occurs. Therefore a method and system to improve the display and organization of port or device parameters is desired.

### SUMMARY OF THE INVENTION

In a fully expanded form, data ports or devices in a network are displayed in a dashboard or widget as a list, along with a corresponding parameter value which is the subject of the dashboard or widget for each port or device. The parameter value for each port is graphically represented by a visually distinctive identifier, where the identifier represents a range of network performance parameter values. A dashboard summary indicator in the form of a series of geometric shapes is displayed in the dashboard, wherein at least one of the symbols generally matches or corresponds to the visually distinctive identifier. Within the geometric shape of the symbol is a number, which represents the number of ports or devices that fall within the range of parameter values to which the symbol corresponds. When the dashboard is minimized the dashboard summary indicator remains in view, allowing a quick way to monitor the results of that dashboard.

This technique can be used on any telecommunication network.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 is a diagram illustrating a local area network (LAN) and wide area network (WAN) as may be incorporated together with the present invention.

FIG. 2 is a diagram of an Ethernet Switch that may be incorporated together with the present invention.

FIG. 3 is a diagram illustrating Fibre Channel (FC) storage area network (SAN) fabrics interconnected via a wide area network (WAN) as may be incorporated together with the present invention.

FIG. 4 is a diagram of a Fibre Channel Switch that may be incorporated together with the present invention.

FIG. 5 is a block diagram of a management station connected to a communications network for operating in accordance with the present invention.

FIG. 6 is a screenshot of an example GUI according to prior art where a list of data ports is sorted in descending order based on the port with the highest data transmit utilization.

FIG. 7 is a screenshot of an example GUI according to the preferred embodiment of the present invention.

FIG. 8 is a screenshot of an example GUI according to the preferred embodiment of the present invention.

### DETAILED DESCRIPTION OF THE PREFERRED EMBODIMENTS

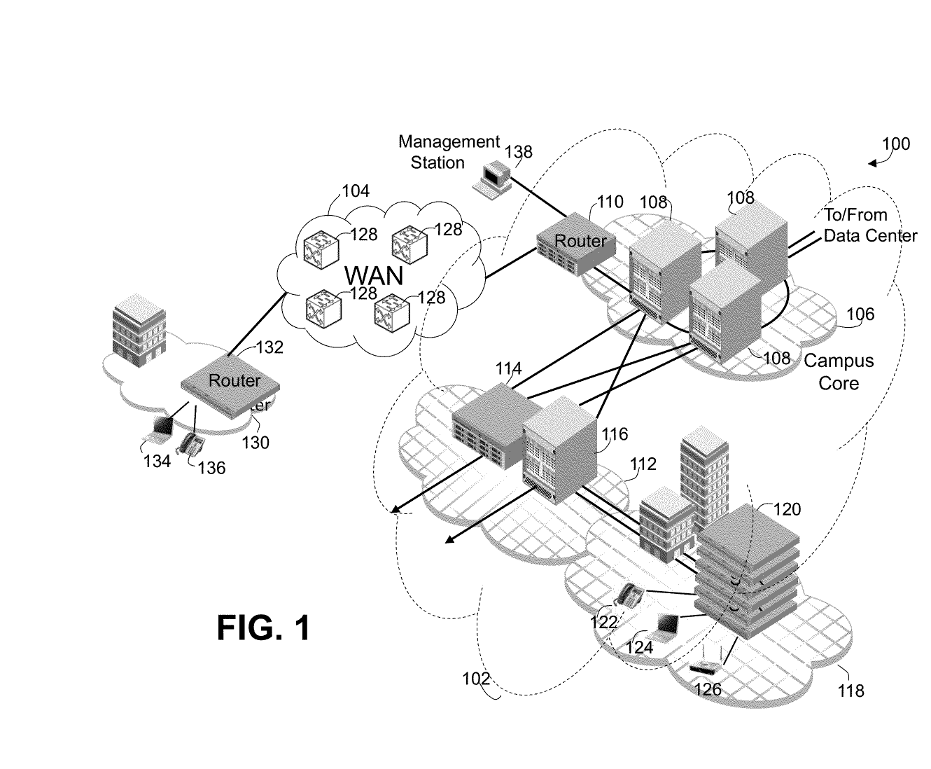

Referring to FIG. 1, an Ethernet network is shown wherein a LAN 102 is interconnected to a remote campus 130 via WAN 104. The campus core 106 includes a plurality of interconnected core switches 108. The core switches 108 are connected to a data center (not shown). A router no is connected to the core switches and the WAN 104. The LAN 102 is connected to the WAN 104 via router no. The core switches 108 are connected to switches 114 and 116 of an aggregation campus 112. The aggregation campus switches 114 and 116 are connected to switches 120 of large network 118 and provide data communication services to the large network's telephone 122, computer 124, and wireless access 126 devices. The aggregation network switches 114 and 116 may also be connected to additional campuses (not shown) in order to provide additional data communication services. The WAN 104 is comprised of a plurality of interconnected Ethernet switches 128 and other networking devices (not shown). WAN 104 is connected to remote campus 130 via a router 132. Router 132 provides data communication services to computers 134 and telephone devices 136. It is understood that this is an exemplary network and numerous other network topologies can be monitored according to the present invention.

In an embodiment of the present invention a management station 138 is connected to router no of the campus core 106. As will be appreciated by one having ordinary skill in the art, the management station 138 allows a network administrator to monitor the data traffic, port utilization, and various other networking characteristics of each switching device in the Ethernet network 100.

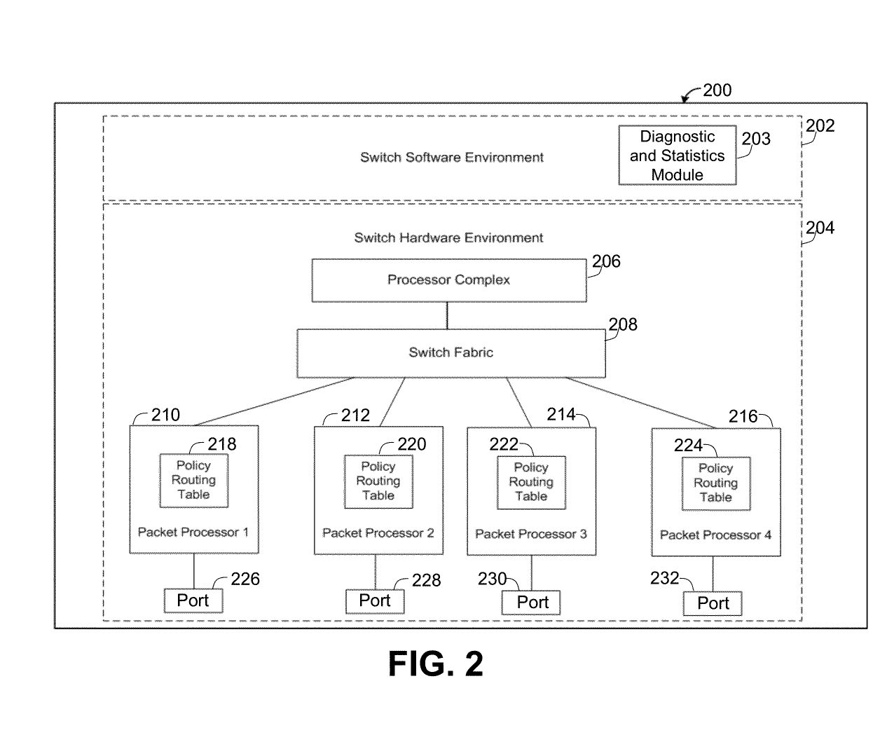

Turning next to FIG. 2, a block diagram of an Ethernet switch or router 200 that may be utilized in Ethernet network 100 is shown. The Ethernet switch 200 comprises a switch software environment 202 and switch hardware environment 204. The software environment 202 includes a diagnostics and statistics module 203 to allow management software access to the various statistical counters in the switch 200, such as receive and transmit rate counters for each port 226, 228, 230, 232. The switch hardware environment 204 has a processor complex 206 that consists of processors as defined. The processor complex 206 is connected to a switch fabric 208, which provides the basic switching operations for the switch 200. The switch fabric 208 is connected to a plurality of packet processors 210, 212, 214, 216. Each packet processor 210, 212, 214, 216 has its own respective policy routing table 218, 220, 22, 224 to provide conventional packet analysis and routing. Each packet processor 210, 212, 214, 216 is connected to its own respective port or ports 226, 228, 230, 232. When the Ethernet switch 200 is implemented in a network such as network 100, the data values of each port 226, 228, 230, and 230 may be monitored and analyzed using management software on a management station, such as management station 136. Again, it is understood that this is an exemplary Ethernet switch architecture and numerous other architectures can be used according to the present invention.

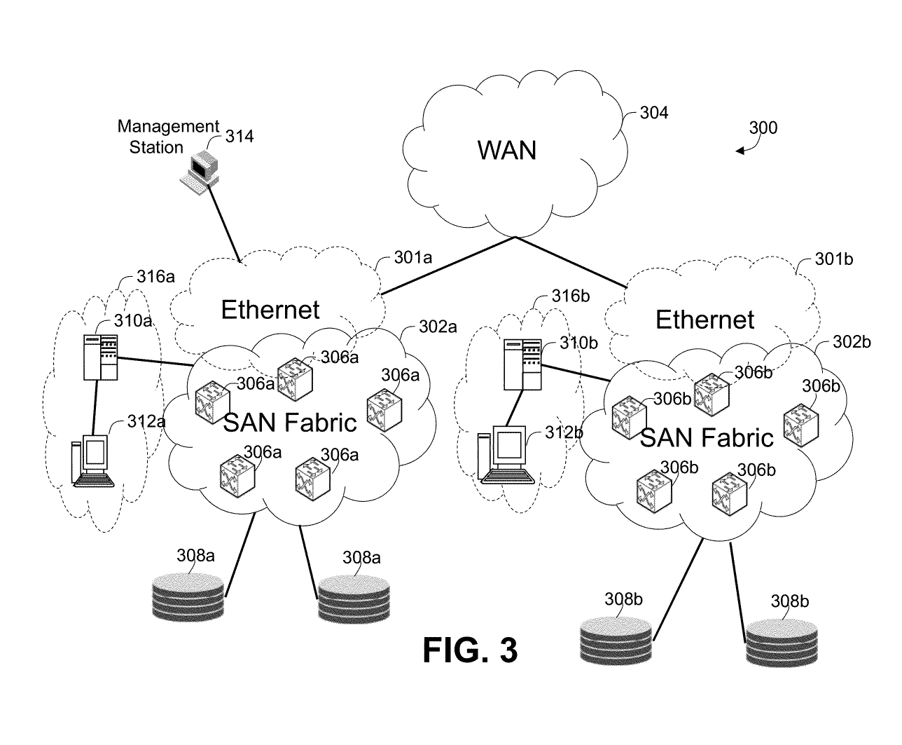

FIG. 3 illustrates a SAN network 300 utilizing the Fibre Channel (FC) protocol. As shown, a plurality of FC SAN fabrics 302a and 302b are interconnected via WAN 304. The SAN fabrics 302a and 302b are comprised of a plurality of FC switches 306a and 306b, respectively. SAN fabric 302a is connected to a plurality of storage devices 308a. Likewise, SAN fabric 302b is connected to a plurality of storage devices 308b. Each SAN fabric 302a and 302b connect their respective storage devices 308a and 308b to application servers 310a and 310b, which are in turn connected to computers 312a and 312b via their respective LANs 316a and 316b. This configuration allows for computer 312a to access storage devices 308b and for computer 312b to access storage devices 308a. As above, this is an exemplary FC SAN architecture and numerous other FC architectures can be managed according to the present invention.

In an embodiment of the present invention a management station 314 is connected to Ethernet LAN 301a and indirectly to Ethernet LAN 301b via WAN 304. Ethernet LANs 301a and 301b are connected to the Ethernet management ports of the switches 306a and 306b to provide a management network for the switches 306a and 306b. As will be appreciated by one having ordinary skill in the art, the management station 314 allows a network administrator to monitor the data traffic, port utilization, and various other networking characteristics using network management software, such that any data congestion may be alleviated.

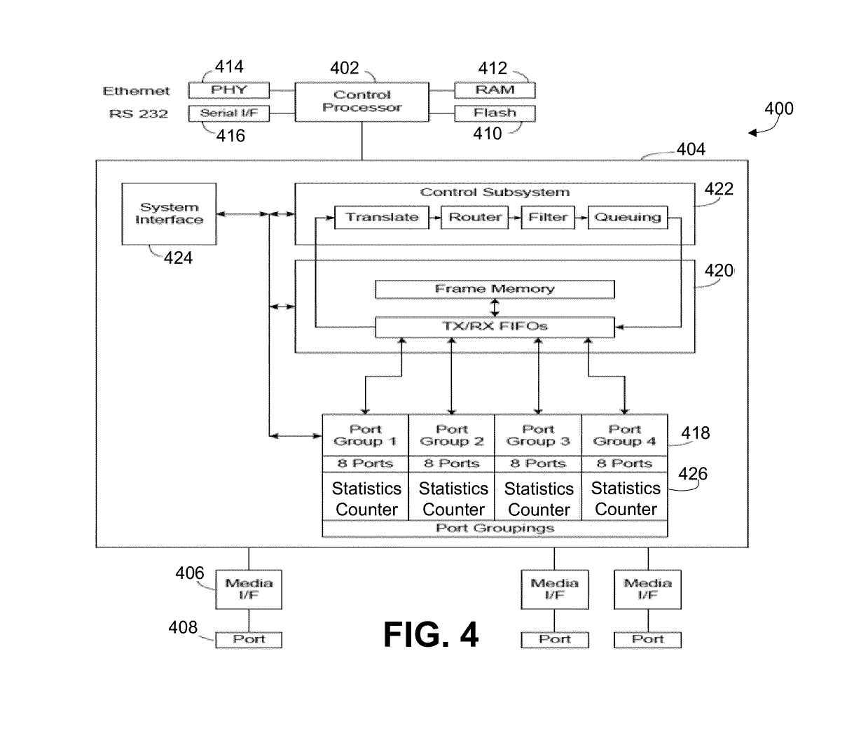

FIG. 4 illustrates a block diagram of a FC switch 400 that may be utilized in accordance with the SAN network 300. A control processor 402 is connected to a switch ASIC 404. The switch ASIC 404 is connected to media interfaces 406 which are connected to ports 408. Generally the control processor 402 configures the switch ASIC 404 and handles higher level switch operations, such as the name server, the redirection requests, and the like. The switch ASIC 404 handles the general high speed inline or in-band operations, such as switching, routing and frame translation. The control processor 402 is connected to flash memory 410 to hold the software, to RAM 412 for working memory and to an Ethernet PHY 414 used for management connection and serial interface 416 for out-of-band management.

The switch ASIC 402 has four basic modules, port groups 418, a frame data storage system 420, a control subsystem 422 and a system interface 424. The port groups 418 perform the lowest level of packet transmission and reception, and include a statistical counter module 426 to allow management software to access the various statistical counters of the switch 400, such as receive and transmit rate counters for each port. Generally, frames are received from a media interface 406 and provided to the frame data storage system 420. Further, frames are received from the frame data storage system 420 and provided to the media interface 406 for transmission out a port 408.

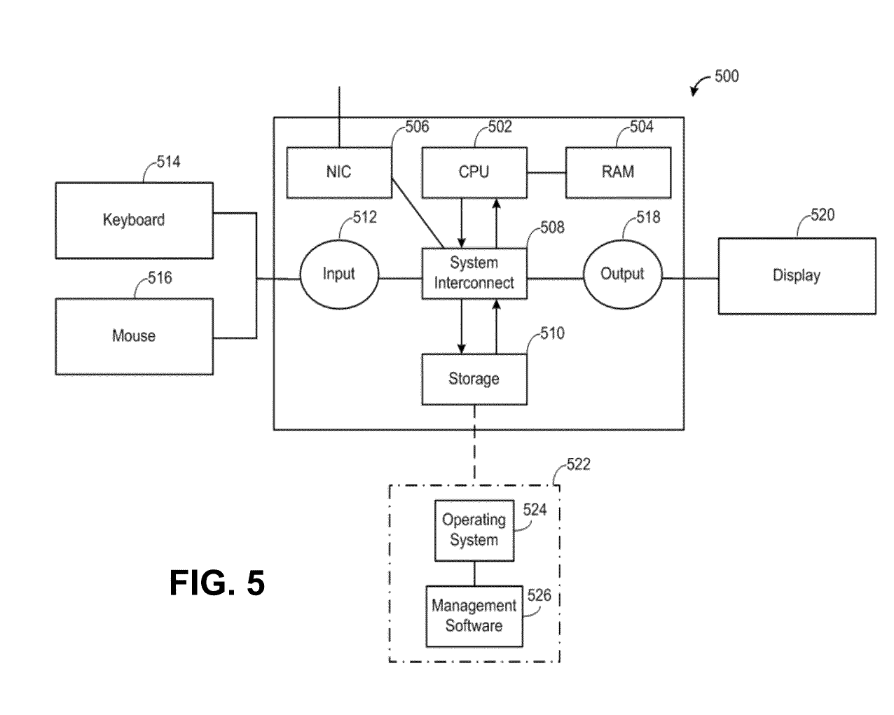

FIG. 5 illustrates a block diagram of a management station 500, similar to management stations 138 and 314, that may be utilized in accordance with the present invention. As shown, the management station 500 is comprised of a central processing unit (CPU) 502, random access memory (RAM) 504, network interface card (NIC) 506, system interconnect 508, storage component 510, input component 512, and output component 518 which are all interconnected via the system interconnect 508. The input component 512 may be connected to an input device such as a keyboard 514 and mouse 516. The output component 518 is connected to a display device 520, such as an LCD monitor. Storage component 510 stores software 522, which typically includes an operating system 524 and network management software 526. The NIC 506 allows the management station 500 to communicate with a network. As understood by those skilled in the art, network management software is typically designed to allow a network administrator to quickly and efficiently monitor and manage a large network via a user interface, often a graphical user interface (GUI). The network management software 526 could be, for example, Brocade Network Advisor by Brocade Communication Systems, Inc. Once booted, the management station 500 loads the operating system 524 from the storage 510 into the RAM 504. From the operating system 524 a user may run the network management software 526, which is then also loaded into the RAM 504. The interface of the network management software 526 is then displayed on the display 520 via the output component 518. The network management software 526 allows a user to monitor numerous performance parameters or network characteristics, such as the number events on the network, number of unused ports of network devices, memory utilization of network devices, bandwidth utilization of network devices, and CPU utilization of network devices. It is understood that this is an exemplary computer system architecture and numerous other computer architectures can be used according to the present invention.

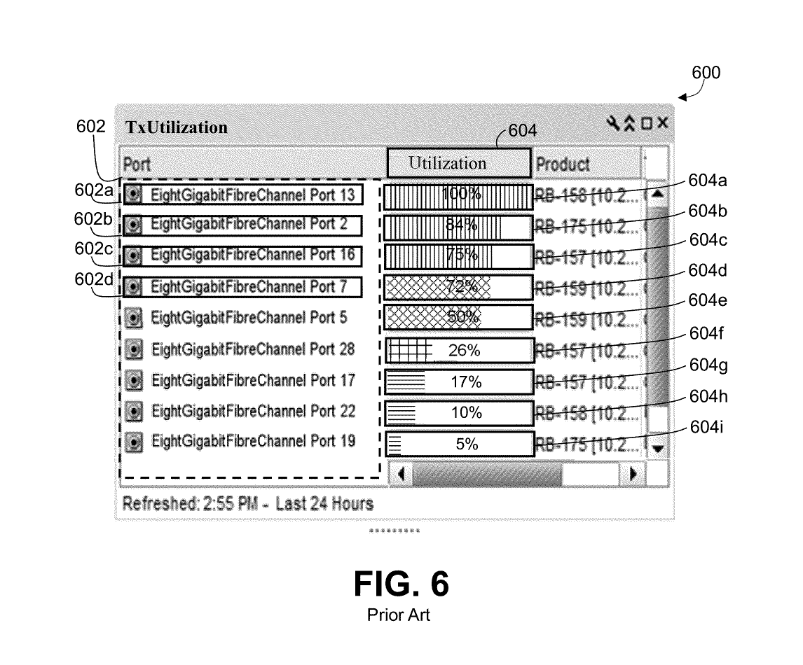

FIG. 6 illustrates an example of a widget 600 of a graphic user interface (GUI) of management software 526 wherein a plurality of ports 602 are sorted in accordance with one version of the prior art. As understood by those having skill in the art, network management software accumulates the particular characteristics of a network by either: (1) polling switches via application programming interface (API), command line interface (CLI) or simple network management protocol (SNMP); or (2) receiving warnings from switches on the network via API or SNMP. The network management software then displays the particular characteristics (e.g., bandwidth utilization) being tracked in a window, such as a widget, for the network administrator. As shown, the plurality of ports 602 are sorted in descending order based on the port having the highest transmit (TX) utilization 604 of the plurality of ports 602. Consequently, the first port 602a in the arrangement has the highest TX utilization value 604a, the second port 602b in the arrangement has the second TX utilization value 604b, and the third port 602c in the arrangement has the third highest data transmit value 604c, The remaining ports are sorted based on their TX utilization value in the same manner as ports 602a through 604c. The TX utilization bar of each port is colored based on the level of utilization. For example, TX utilization bars 604a, 604b, and 604c are red to indicate utilization between 75% and 100%. Likewise, TX utilization bars 604d and 604e are represented as orange bars, which indicate utilization between 50% and 75%. TX utilization bar 604f is represented as a yellow bar, which indicates utilization between 25% and 50%. TX utilization bars 604g, 604h, and 604i are represented as blue bars, which indicates utilization between 0% and 25%. As would be understood by those of ordinary skill in the art, any color or other distinct visual identifier could be tied to any particular performance parameter value range. For example, red could correspond to 90% to 100%, as opposed to 75% to 100%. Moreover, rather than using colors, patterns or other distinct visual identifier (e.g., a striped bar) could be used. Distinct visual identifier, in its broadest sense, is intended to be any visual identifier capable of representing a performance parameter value range (e.g., red for 75% to 100% utilization). While there are benefits to displaying the parameters of each port in this fashion, an administrator is still required to review and analyze the entire list of ports to determine how many ports fall within a particular utilization range. Moreover, listing all of the ports in this fashion occupies valuable space on the GUI display. An administrator may only be interested, for example, in knowing how many ports fall within a particular performance parameter range, as opposed to the specific utilization of each individual port.

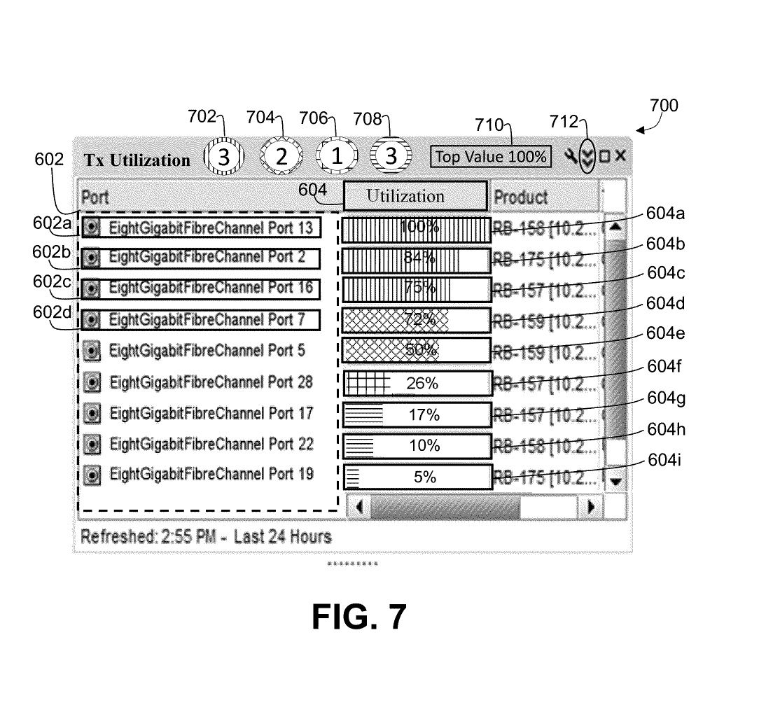

FIG. 7 illustrates an example of the widget 700 of management software 526, wherein dashboard symbols 702, 704, 706, 708, and 710 are displayed based on the plurality of ports 602 and their utilization 604 according to a preferred embodiment of the present invention. For purposes of simplicity, the same element numbering will be used for the same elements from FIG. 6. The ports 602 are displayed and organized based on their TX utilization 604, as discussed in FIG. 6. However, this embodiment includes dashboard symbols 702, 704, 706, 708. Each of those symbols has a particular geometry, in this case a circle. However, it would be apparent to those having ordinary skill in the art that the symbols of the indicator could be any geometric shape (e.g., triangle, square, etc.) and that each level could be a different shape based on the particular value of the parameter corresponding to each symbol.

Each symbol corresponds to the particular port(s) falling within one of the ranges previously discussed (e.g., the range of 75% to 100% utilization). More specifically, symbol 702 visually corresponds to TX utilization bars 604a, 604b, 604c (i.e., 3 ports) having a utilization range of 75% to 100% (i.e., indicated by red). This correspondence is evident because: (1) the circle 702 has a red ring, which corresponds to the red bars of TX utilization bars 604a, 604b, and 604c; and (2) the number in the circle (i.e., 3) corresponds to the number of ports having parameter values falling within the 75% to 100% utilization range (i.e., 3). Similarly, symbol 704 visually corresponds to TX utilization bars 604d and 604e (i.e., 2 ports) having a utilization range of 50% to 75% (i.e., indicated by orange). This correspondence is evident because: (1) the circle 704 has an orange ring, which corresponds to the orange bars of TX utilization bars 604d and 604e; and (2) the number in the circle (i.e., 2) corresponds to the number of ports having parameter values falling within the 50% to 75% utilization range (i.e., 2). Likewise, symbol 706 visually corresponds to TX utilization bar 604f (i.e., 1 ports) having a utilization range of 25% to 50% (i.e., indicated by yellow). This correspondence is evident because: (1) the circle 706 has a yellow ring, which corresponds to the yellow of TX utilization bar 604f; and (2) the number in the circle (i.e., 1) corresponds to the number of ports having parameter values falling within the 25% to 50% utilization range (i.e., 1). Similarly, symbol 708 visually corresponds to TX utilization bars 604g, 604h, 604i (i.e., 3 ports) having a utilization range of 0% to 25% (i.e., indicated by blue). This correspondence is evident because: (1) the circle 708 has a blue ring, which corresponds to the visually distinctive identifier (i.e., blue) of the TX utilization bars 604g, 604h, 604i; and (2) the number in the circle (i.e., 3) corresponds to the number of ports having parameter values falling within the 0% to 25% utilization range (i.e., 3). This embodiment may allow a network administrator to easily and efficiently monitor the overall number of ports by group based on their TX utilization. This is particularly helpful as it allows an administrator to immediately recognize the number of ports that fall within the threshold of parameters that may be more relevant and critical to seamless network performance (e.g., the 75% to 100% TX usage range). While the present embodiment discloses using symbols with a colored ring, those having ordinary skill in the art would appreciate that the symbols could be arranged in any fashion suitable to convey the information discussed above. For example, the symbols could instead be completely filled with a color corresponding to a particular utilization bar, with the corresponding parameter value remaining in the center of the symbol.

While the present embodiment discloses utilizing colors to correspond the symbols to the parameter value ranges of the ports, it should be understood that whichever distinct visual identifier is used to represent a certain parameter value range, the same visual identifier may be used by the symbols. For example, if the distinct visual identifier for a parameter value range is a pattern of lines (e.g., vertical lines, horizontal lines, etc.), the same pattern of lines could be used for the corresponding symbol.

An additional feature of the present invention may be an additional dashboard display symbol 710, which represents the highest total value of the parameter being monitored by the widget 700. More specifically, symbol 710 corresponds to TX utilization bar 604a, which shows 100% TX utilization by port 602a. This additional information may be particularly advantageous, as it allows an administrator to immediately know the highest value TX utilization of the ports corresponding to symbol 702. For example, an administrator may not be overly concerned if the highest TX utilization value of a port is 76%, even though the port would appear in symbol 702. However, with 100% utilization an administrator would likely take immediate remedial action to bring the utilization down.

Yet another feature of the present invention may be the capability of the symbols 702, 704, 706, 708, or 710 to flash when a change occurs. For example, if the number of ports corresponding to symbol 702 jumps from three to six, the symbol 702, and any other symbol that changed, may flash to alert the administrator of the change. This may be a particularly useful feature to an administrator, as it allows the administrator to immediately notice any change. Seeing such a change without an eye catching visual may make it difficult to realize a change has occurred, given that the GUI of management software 525 may be heavily cluttered with other widgets. While the present embodiment teaches using a flash as an indicator of change, it would be understood by those of ordinary skill in the art that any visual indication could be utilized to alert a change, including but not limited to flashing, beeping, pulsing, or changing the shape of the symbol (e.g., from a circle to a triangle).

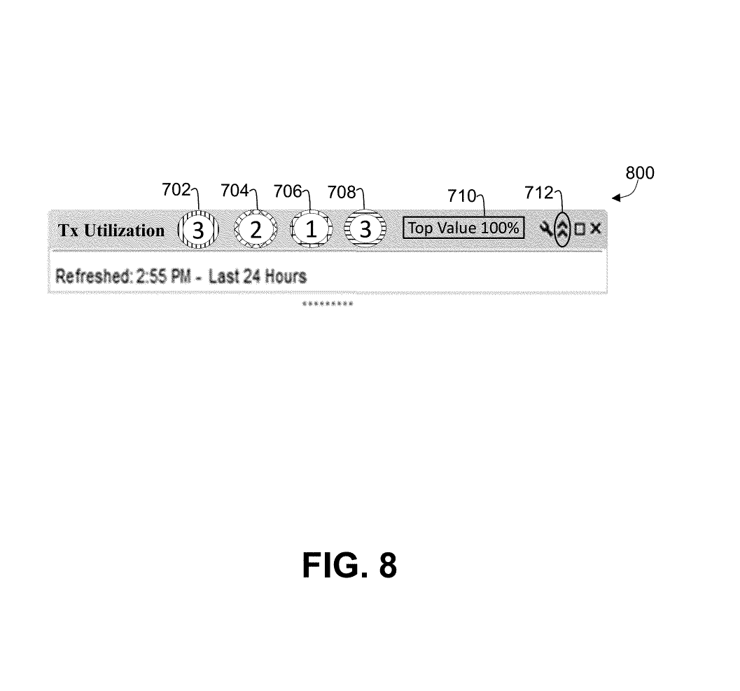

Another feature of the present invention may be to display the symbols 702, 704, 706, 708, and 710 even when widget 700 is minimized. Specifically, when an administrator chooses to minimize the widget 700, he may select button 712, which will cause the list of ports and their TX utilization to collapse, as shown in FIG. 8. However, because all of the symbols still remain visible in the minimized form, an administrator may still monitor the generally important information being monitored by the minimized widget 800. If any changes occur, the administrator may be visually alerted as previously discussed (e.g., by flashing). In that case, the administrator may click on button 712 again to expand the minimized widget 800 and view the individual port utilization in detail in widget 700. This feature may be beneficial to an administrator, as administrators are generally unable to visually monitor any ports being tracked by a particular widget when the widget is in the minimized state.

While the present embodiment discusses the tracking of TX utilization, it would be understood by those of ordinary skill in the art that any network parameter could be implemented as part of the present invention. For example, rather than using a widget to track TX utilization, memory utilization, bandwidth, packet loss, hardware errors, timeouts, switch priority, and the like may be monitored instead. Alternatively, all of these and similar statistics could be monitored at the same time using a plurality of different widgets. The present invention may allow an administrator to monitor significantly more network parameters by minimizing widget windows (which saves screen space) and viewing only the dashboard summary indicators of concern.

While communication networks using the Ethernet and FC protocols, with switches, routers and the like, have been used as the example in the Figures, the present invention can be applied to any type of data communication network. Moreover, the presently disclosed invention may be utilized in any communications network where a network element, such as a port, switch, hub, user computer, etc, is monitored.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
monitoring a network parameter value of a plurality of network elements in a data communication network;
corresponding a different distinct visual identifier to each of a plurality of predetermined network parameter value ranges;
generating a plurality of symbols, one for each of said plurality of predetermined network parameter value ranges, said symbol including the particular distinct visual identifier for the respective predetermined network parameter value range and including a numeric value indicating the number of network elements with a network parameter value falling within the respective predetermined network parameter value range; and
displaying said plurality of symbols on a display device.

2. The method of claim 1, further comprising:
displaying a numeric value that shows the monitored performance parameter value of the network element with the highest network parameter value.

3. The method of claim 1, wherein said plurality of symbols are displayed as part of a widget.

4. The method of claim 3, wherein said plurality of symbols are displayed when the widget is minimized.

5. The method of claim 1, wherein the particular distinct visual identifier is a color and the symbol comprises a geometric shape and the geometric shape visually corresponds to the particular distinct visual identifier by color.

6. The method of claim 1, wherein the network elements are ports and the network parameter value is a ported-based value.

7. The method of claim 1, wherein the network elements are switches and the network parameter value is a switch-based value.

8. The method of claim 1, wherein a symbol visually alerts a user when the numeric value of the symbol changes.

9. The method of claim 8, wherein the visual alert is a flashing of the symbol.

10. A non-transitory computer readable storage medium or media having computer-executable instructions stored therein for an application which performs the following method, the method comprising:
monitoring a network parameter value of a plurality of network elements in a data communication network;
corresponding a different distinct visual identifier to each of a plurality of predetermined network parameter value ranges;
generating a plurality of symbols, one for each of said plurality of predetermined network parameter value ranges, said symbol including the particular distinct visual identifier for the respective predetermined network parameter value range and including a numeric value indicating the number of network elements with a network parameter value falling within the respective predetermined network parameter value range; and
displaying said plurality of symbols on a display device.

11. The non-transitory computer readable storage medium or media of claim 10, further comprising:
displaying a numeric value that shows the monitored performance parameter value of the network element with the highest network parameter value.

12. The non-transitory computer readable storage medium or media of claim 10, wherein said plurality of symbols are displayed as part of a widget.

13. The non-transitory computer readable storage medium or media of claim 12, wherein said plurality of symbols are displayed when the widget is minimized.

14. The non-transitory computer readable storage medium or media of claim 10, wherein the particular distinct visual identifier is a color and the symbol comprises a geometric shape and the geometric shape visually corresponds to the particular distinct visual identifier by color.

15. The non-transitory computer readable storage medium or media of claim 10, wherein the network elements are ports and the network parameter value is a ported-based value.

16. The non-transitory computer readable storage medium or media of claim 10, wherein the network elements are switches and the network parameter value is a switch-based value.

17. The non-transitory computer readable storage medium or media of claim 10, wherein a symbol visually alerts a user when the numeric value of the symbol changes.

18. The non-transitory computer readable storage medium or media of claim 17, wherein the visual alert is a flashing of the symbol.

19. A computer system comprising:
a processor;
a display device coupled to said processor; and
storage coupled to said processor and storing computer-executable instructions for an application which cause said processor to perform the following steps:
monitoring a network parameter value of a plurality of network elements in a data communication network;
corresponding a different distinct visual identifier to each of a plurality of predetermined network parameter value ranges;
generating a plurality of symbols, one for each of said plurality of predetermined network parameter value ranges, said symbol including the particular distinct visual identifier for the respective predetermined network parameter value range and including a numeric value indicating the number of network elements with a network parameter value falling within the respective predetermined network parameter value range; and
displaying said plurality of symbols on a display device.

20. The computer system of claim 19, further comprising:
displaying a numeric value that shows the monitored performance parameter value of the network element with the highest network parameter value.

21. The computer system of claim 19, wherein said plurality of symbols are displayed as part of a widget.

22. The computer system of claim 21, wherein said plurality of symbols are displayed when the widget is minimized.

23. The computer system of claim 19, wherein the particular distinct visual identifier is a color and the symbol comprises a geometric shape and the shape visually corresponds to the particular distinct visual identifier by color.

24. The computer system of claim 19, wherein the network elements are ports and the network parameter value is a ported-based value.

25. The computer system of claim 19, wherein the network elements are switches and the network parameter value is a switch-based value.

26. The computer system of claim 19, wherein a symbol visually alerts a user when the numeric value of the symbol changes.

27. The computer system of claim 25, wherein the visual alert is a flashing of the symbol.
